(19) United States
(12) Patent Application Publication
(10) Pub. No.: US 2009/0263570 A1
(43) Pub. Date: Oct. 22, 2009

(54) Plating method for processing electrical connector

(75) Inventors: Qing-Man Zhu, Kunshan (CN); Xue-Liang Zhang, Kunshan (CN); Chien-Chiung Wang, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/386,628

(22) Filed: Apr. 21, 2009

(30) Foreign Application Priority Data
Apr. 21, 2008 (CN) 200810023794.8

(51) Int. Cl. B05D 5/12

(52) U.S. Cl. 427/123

(57) ABSTRACT

A plating method is adapted for applying a layer of metal to an electrical connector (1) The plating method includes the steps of: (1) providing a barrel (2) defining an internal room (21) and an insulative member (4); (2) inserting the insulative member into the internal room of the barrel and having the insulative member firmly resisting against the inner surface of the barrel; (3) plating a layer of metal around an outer surface of the barrel.

### BACKGROUND OF THE INVENTION

1. Field of the Invention

The present invention relates to a method, and more particularly to a method for effectively masking an internal surface of a barrel of a RF connector during a plating process.

2. Description of the Prior Art

Chinese Patent No. CN2749100 issued on Dec. 28, 2005 discloses an RF (Radio Frequency) connector. The RF connector is plated with a metallic layer thereon and comprises steps of: (1) providing a metallic tube and an insulative member; (2) applying a metallic layer to the metallic tube; and (3) inserting the insulative member into the metallic tube. However, the internal surface of the metallic tube is usually plated by metal. Thus, it would result in material waste for plating metal on the internal surface of the barrel.

Hence, an improved plating method for processing an electrical connector is needed to solve the above problem.

### BRIEF SUMMARY OF THE INVENTION

Object of the present invention is to provide a plating method for processing a layer of metal onto a barrel of an electrical connector and avoiding plating a layer of metal to the internal surface of the tube.

The present invention provides a plating method for applying a layer of metal to an electrical connector. The plating method comprises the steps of: (1) providing a barrel defining an internal room and an insulative member; (2) inserting the insulative member into the internal room of the barrel and having the insulative member firmly resisting against the inner surface of the barrel; (3) plating a layer of metal around an outer surface of the barrel. The barrel receiving the insulative member is plated with a layer of metal to avoid plating the metal around the inner surface of the barrel.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an exploded view of an electrical connector according to the present invention;

FIG. 2 is a perspective view of the electrical connector as shown in FIG. 1; and

FIG. 3 is a cross-sectional view of the electrical connector as shown in FIG. 2, taken along line 3-3.

### DETAILED DESCRIPTION OF THE INVENTION

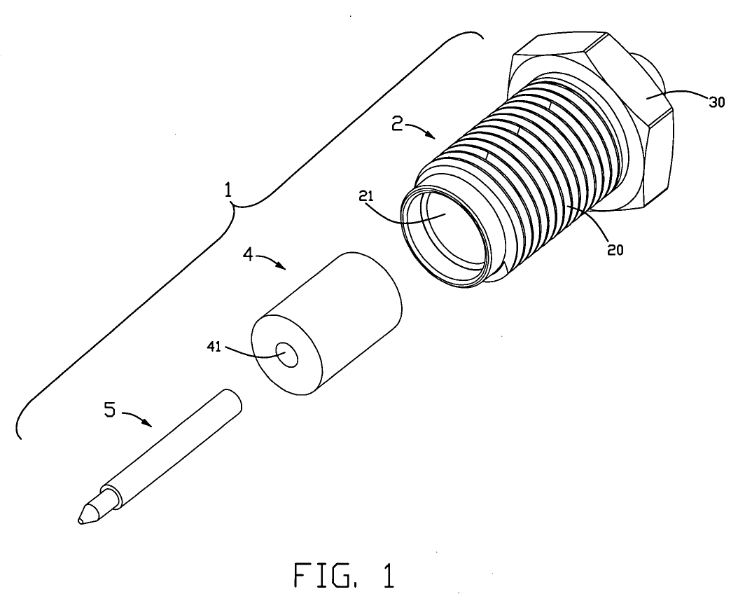

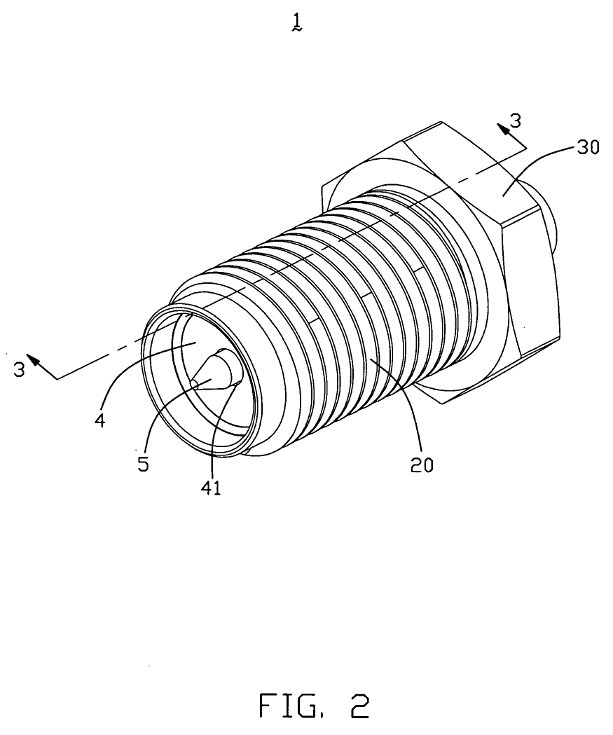

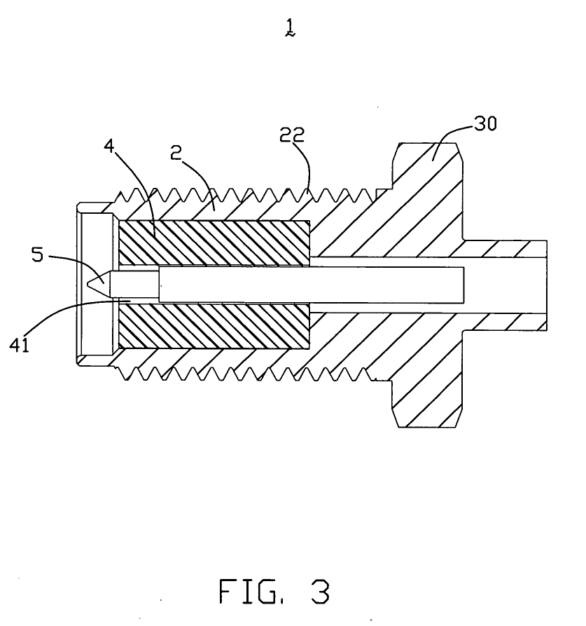

Reference will now be made to the drawing figures to describe the present invention in detail. Referring to FIGS. 1-3, an electrical connector 1 comprises a barrel 2, an insulative member 4, and a central terminal 5 mounted to the insulative member 4.

The electrical connector 1 is an RF connector. The barrel 2 has an operating portion 30 and an annular portion 20 extending from the operating portion 30. The operating portion 30 and the annular portion 20 are made from metal material and molded as a whole. The barrel 2 is made from brass-zinc alloy material. The annular portion 20 defines an internal room 21 therein for receiving the insulative member 4. The insulative member 4 is firmly retained into the internal room 21 of the barrel 2 without any intervals between the insulative member 4 and an inner surface of the barrel 2. The insulative member 4 comprises an axial bore 41 for receiving the central terminal 5. The barrel 2 has a plurality of whorls 22 formed on the outer surface of the barrel.

During applying a layer of metal to the electrical connector 1, the plating method comprises the steps of: (1) providing the barrel 2 and the insulative member 4; (2) inserting the insulative member 4 into the internal room 21 of the barrel 2 and having the insulative member 4 firmly resisting against the inner surface of the barrel 2; (3) plating a layer of metal around an outer surface of the barrel 2. In such a manner, the barrel 2 receiving the insulative member 2 is plated with a layer of metal to avoid plating the metal around the inner surface of the barrel 2.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A method of plating a metallic layer over an outer surface of a barrel of a RF connector, comprising the steps of:
1) providing a barrel having an internal chamber and an outer surface;
2) inserting a insulative member into the chamber masking the internal surface of the barrel; and
3) applying a metallic layer over the outer surface.

2. A plating method as claimed in claim 1, wherein said barrel has an operating portion and an annular portion extending from the operating portion, the operating portion and the annular portion are made from metal material and molded as a whole.

3. A plating method as claimed in claim 2, wherein said barrel is made from brass-zinc alloy material.

4. A plating method for applying a layer of metal to an electrical connector comprising the steps of:
providing a barrel defining an internal room and an insulative member;
inserting the insulative member into the internal room of the barrel and having the insulative member firmly resist against an inner surface of the barrel; and
plating a layer of metal around an outer surface of the barrel.

5. A plating method as claimed in claim 4, wherein said electrical connector is an RF (Radio Frequency) electrical connector.

6. A plating method as claimed in claim 4, wherein said barrel has an operating portion and an annular portion extending from the operating portion, the operating portion and the annular portion are made from metal material and molded as a whole.

7. A plating method as claimed in claim 6, wherein said barrel is made from brass-zinc alloy material.

8. A plating method as claimed in claim 4, wherein said insulative member comprises an axial bore for receiving a central terminal.
